(19) United States
(12) Patent Application Publication
(10) Pub. No.: US 2004/0252191 A1
(43) Pub. Date: Dec. 16, 2004

(54) Automobile entertainment apparatus display with integrated antenna

(76) Inventors: J. Roger Davis, Russiaville, IN (US); Ashby E. Holston, Kokomo, IN (US); Steven C. Bower, Kokomo, IN (US)

Correspondence Address: DELPHI TECHNOLOGIES, INC., M/C 480-410-202, PO BOX 5052, TROY, MI, 48007, US

(21) Appl. No.: 10/461,096

(22) Filed: Jun. 13, 2003

(51) Int. Cl. H04N 7/18

(52) U.S. Cl. 348/148; 348/61

(57) ABSTRACT

The present invention provides an automobile entertainment apparatus display with an integrated antenna. The antenna may be integrated with the display in multiple ways, including disposing the antenna in a cavity defined by the display, mounting the antenna to the display, disposing the antenna in an aperture defined by the display, and forming the antenna on the display. The present invention also provides a display including a first planar layer adjacent a second planar layer. The first planar layer includes one or more light-emitting elements, and the first and second layers together define a cavity in which the antenna is disposed.

### TECHNICAL BACKGROUND

The invention relates to entertainment apparatuses used in automobiles, and more particularly to the integration of an antenna with the display of an entertainment apparatus.

### BACKGROUND OF THE INVENTION

Radio receivers have been used in automobiles for decades to enable passengers to enjoy music, radio shows and the like. More recently, flat panel television monitors and digital video disc (“DVD”) players incorporating receiver capabilities have become more widely used in automobiles so that passengers can view DVD movies, play video games, or watch television. The radio receivers, DVD players and television monitors have viewable displays that enable their users to navigate and manipulate the many functions of the devices. Radio frequency (“RF”) communication with the entertainment systems is becoming more prevalent in automotive applications. Examples of RF communication between one device or system and the entertainment systems include the following:

1. RF remote controls that allow users to operate the entertainment system via a handheld unit and without the need to point the unit at a receiver as required in infrared-based remote controls. The need for an infrared receiver physically mounted in the vehicle to benefit rear seat passengers is not required with an RF remote.

2. Door unlock and security systems utilizing a small RF remote control, e.g., key chain-sized remote controls for unlocking/locking car doors and/or activating a vehicle alarm system. The RF receiver for such systems can migrate to the entertainment system eliminating the need for a separate assembly in the vehicle.

3. Add-on devices such as CD changers often communicate to the entertainment system via an RF signal rather than a hard-wire interface. Although present systems utilize an RF frequency in the FM broadcast band, future systems may migrate to the 2.4 GHz band.

4. Bluetooth®-enabled cellular telephones can communicate to the entertainment system for hands-free calling, data access, vehicle control and diagnostics, phonebook access, transfer of phone account information to an embedded vehicle phone, and many other functions. BLUETOOTH is a registered trademark of Bluetooth SIG, Inc., a Delaware corporation.

5. Many home networking systems are wireless operating in the 2.4 GHz spectrum. Because a homeowner's vehicle is often parked in a garage or driveway well within the range of wireless home networks, transfer of data between the vehicle and home network is possible. Such data may consist of music, navigational information and vehicle maintenance needs.

Currently, technology requires that an antenna and a display be separately mounted. Both the antenna and the display are important features of the receiver. The antenna enables the receiver to receive RF signals broadcast from wireless devices used in the automobile such as remote controls or Bluetooth®-enabled devices. The display enables the receiver's user to enjoy the receiver's features. For example, in the case of a Bluetooth®-enabled phone, the user can see the incoming phone number and/or name on the radio display as a phone call is received.

When an antenna and a display are separately mounted to a receiver's circuit board and the circuit board is installed in the receiver, the circuit board is typically arranged so that the display is positioned towards the front of the receiver. Due to this particular placement of the display and the placement of numerous other components on the circuit board, the antenna is often positioned away from the front of the radio, causing poor RF performance. To account for this, an external antenna is used at a higher cost and lower reliability due to connectors and wiring.

### SUMMARY OF THE INVENTION

Accordingly, the present invention provides an integrated receiver display and antenna. The integration of the antenna with the display conserves space on the circuit board because room is not required to separately mount both the antenna and the display—only the display must be mounted. Similarly, when the display is positioned near the front of the receiver, the antenna is necessarily positioned there as well. Therefore, the present invention simultaneously increases RF performance within the vehicle, saves circuit board space and reduces assembly labor.

In one embodiment of the present invention, an automobile entertainment apparatus includes a receiver with an integrated display and antenna. In one form of this embodiment, the antenna is mounted to the display. In another form of this embodiment of the present invention, the display defines a cavity in which the antenna is disposed. In still another form of this embodiment of the present invention, the display defines an aperture in which the antenna is disposed. In yet another form of this embodiment, the antenna is formed on the display.

In another embodiment of the present invention, a display for use in an automobile entertainment apparatus includes a planar layer having one or more light-emitting elements and an antenna integrated with the planar layer. In one form of this embodiment of the present invention, the antenna is mounted to the planar layer. In another form of this embodiment, the planar layer defines a cavity in which the antenna is disposed. In still another form of this embodiment, the planar layer defines an aperture in which the antenna is disposed. In yet another form of this embodiment of the present invention, the antenna is formed on the planar layer.

In still another embodiment of the present invention, the display includes a first planar layer adjacent a second planar layer. The first and second layers together define a cavity in which the antenna is disposed.

### BRIEF DESCRIPTION OF THE DRAWINGS

The above-mentioned and other features and objects of this invention, and the manner of attaining them, will become more apparent and the invention itself will be better understood by reference to the following description of an embodiment of the invention taken in conjunction with the accompanying drawings, wherein:

FIG. 1A is the front perspective of a radio receiver including a display suitable for use with the present invention.

FIG. 1B is the front perspective of a television monitor and receiver including a display suitable for use with the present invention.

FIG. 2 is a frontal view of the display of the present invention.

FIG. 3 is a partial cross-sectional view of the display of the present invention, taken along the line 2-2 of the display shown in FIG. 2, wherein the display defines a cavity in which the antenna is disposed.

FIG. 4 is a rear view of the display of the present invention wherein the antenna is mounted to the display.

FIG. 5 is an exploded rear view of the display of the present invention wherein the display defines an aperture in which the antenna is disposed.

FIG. 6 is a rear view of the display of the present invention wherein an antenna is formed on the display.

FIG. 7 is a frontal view of the display of the present invention wherein the display has two layers that together define a cavity in which the antenna is disposed.

FIG. 8 is a partial cross-sectional view of the display of the present invention, taken along the line 3-3 of the display shown in FIG. 7, wherein the display's layers together define a cavity in which the antenna is disposed.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiment disclosed below is not intended to be exhaustive or limit the invention to the precise form disclosed in the following detailed description. Rather, the embodiment is chosen and described so that others skilled in the art may utilize its teachings.

Display technologies suitable for use in the present invention include vacuum fluorescent displays (“VFDs”), liquid crystal displays (“LCDs”), light-emitting diodes (“LEDs”), gas plasma displays, and organic light emitting displays (“OLEDs”), which are also known as organic electroluminescent displays (“OELs”).

A VFD generally includes a cathode, grid, and anode sealed in a high-vacuum glass envelope. The cathode is a directly heated, fine tungsten wire coated by an alkaline earth metal oxide. The grid is a thin metal mesh, and the anode is a segment or dot formed as a conductive electrode on which phosphor is formed. The shape of the phosphor segment or the arrangement of illuminated phosphor dots creates the characters or symbols. Electrons emitted from the cathode are accelerated with a positive potential applied to both the grid and anode, which upon collision excite the phosphor on the anode to emit a very bright light. The control of the positive or negative potential on the grid and anode creates the desired characters or segments.

Chip-in-glass (“CIG”) is a VFD technology that uses thin chips hidden inside the vacuum tube and mounted to the phosphor display area. CIG requires very few lead-outs, and because drivers are included in the vacuum tube, space may be conserved on a circuit board when the space for the display is small and crowded with other components.

Liquid crystal technology is another display technology used in flat screen television monitors and other smaller electronic devices. An LCD consists primarily of two transparent electrodes with liquid crystal material placed between them. The liquid crystal changes the phase of the light passing through it and this phase change can be controlled by the voltage applied between the electrodes. An LCD is made with either a passive matrix or an active matrix display grid. The passive matrix LCD has a grid of conductors with pixels located at each intersection in the grid. A current is sent across two conductors on the grid to control the light for any pixel. Active matrixes have transistors located at each pixel intersection, requiring less current to control the illuminating capability of each pixel.

Chip-on-glass (“COG”) is a LCD technology that uses an adhesive to mount the LCD's driver to the display itself. The technology increases the LCD's pixel density and reduces the overall size of an LCD module.

LED and gas plasma work by lighting up display screen positions base on the voltages at different gird intersections. LCDs require less energy than the LED and gas plasma technologies.

OLED, or OEL, displays use emissive technology in that they emit their own light. They comprise thin layers of individual carbon-based elements that emit light when an electric current is passed through them This capability eliminates the need for the backlighting used on many LCDs. Without the backlighting, OLEDs and OELs can be used to create thinner panels that consume less power.

Several short-range wireless RF technologies exist in order to promote wireless communication between devices such as remote controls and receivers. The most notable of these technologies include 802.11 and Bluetooth®.

802.11 is a family of specifications for wireless local area networks developed by the Institute of Electrical and Electronics Engineers. The family of specifications includes 802.11, 802.11a, 802.11b, and 802.11g. The most recently approved specification, 802.11g, provides wireless transmission over short distances at up to fifty-four (54) megabits per second (Mbps). 802.11g is also a half-duplex protocol, i.e., it can either send data or receive data but can not do both at the same time. Under utopian conditions, the half-duplex protocol results in a limited bandwidth of about 3.4 megabytes per second (Mbps) unidirectional connectivity. 802.11g operates in and is compatible with the 2.4 gigahertz (“GHz”) Industry Scientific and Medical (“ISM”) band.

Bluetooth® is a short-range RF technology that does not require line-of-sight positioning of the communicating units. When a user activates a Bluetooth®-enabled unit, the unit instantly scans for another enabled unit within the immediate vicinity. Once such a unit is located, the units establish small networks between each other and exchange address information without further involvement by the user. Bluetooth® offers data transfer at up to 723.2 kilobits per second (“Kbps”) in half-duplex mode and 433.9 Kbps in full-duplex mode, i.e., a mode in which data can be simultaneously sent and received. Bluetooth® also operates in the 2.4 GHz ISM band.

Home-RF is the most undeveloped of the short-range RF technologies. Initially created by the HomeRF Working Group. Inc. to provide a standard for inexpensive data and voice communication to be used in the home, the Home-RF technology is not widely used at this time. Home-RF operates in the 2.45 GHz range of the ISM band.

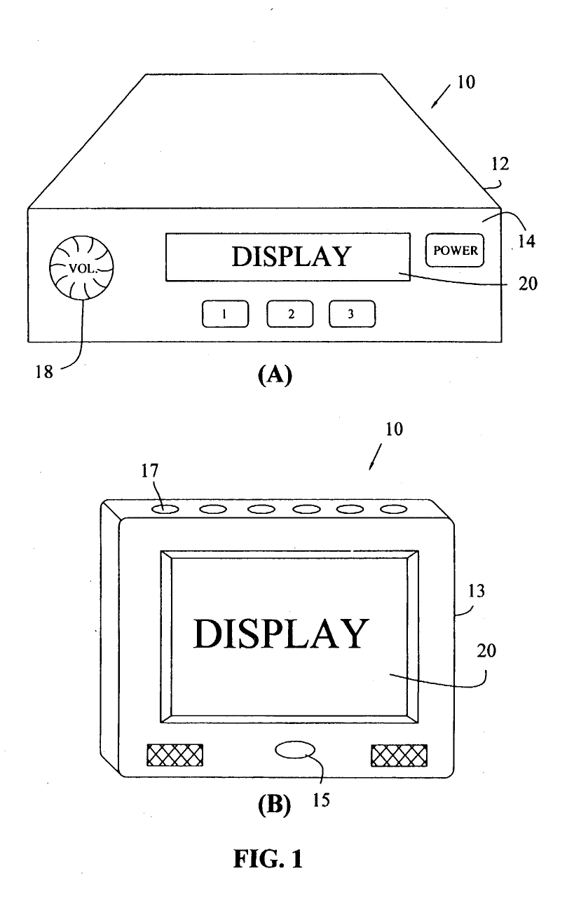

Shown in FIGS. 1A and 1B are entertainment apparatuses 10 suitable for use in automobiles and in which the present invention may be used. Referring to FIG. 1A, entertainment apparatus 10 includes radio receiver 12 having power button 14, volume control 16 and display 20. Display 20 enables the user of radio receiver 12 to view the radio station to which radio receiver 12 is tuned, volume levels, radio frequencies (i.e., FM/AM), CD/tape tracks and other features of radio receiver 10.

FIG. 1B shows another form of entertainment apparatus 10 in which the present invention may be used. Entertainment apparatus 10 includes television receiver 13. Receiver 13 may include a television monitor integrated with a receiver, and DVD player integrated with a receiver, or both. Receiver 13 has power button 15, volume control 17 and display 20. Display 20 enables the user of receiver 13 to view television, DVD movies, video game graphics and the like. Display 20 is also used to monitor the volume level of entertainment apparatus 10. Entertainment apparatus 10 also includes one or more circuit boards conventionally used to provide the television and DVD operation well known in the art. The circuit board is in communication with RF receiving circuitry which enables entertainment apparatus 10 to receive RF signals from a transmitting device such as a remote control. The RF receiving circuitry may be mounted on the circuit board or coupled to the circuit board by other known methods in the art (e.g., electrical, mechanical, optical, etc., type couplings), and the antenna of the present invention is adapted to be in communication with the RF receiving circuitry. Specific details of the RF receiving circuitry are not needed to understand the present invention and accordingly will not be described in further detail.

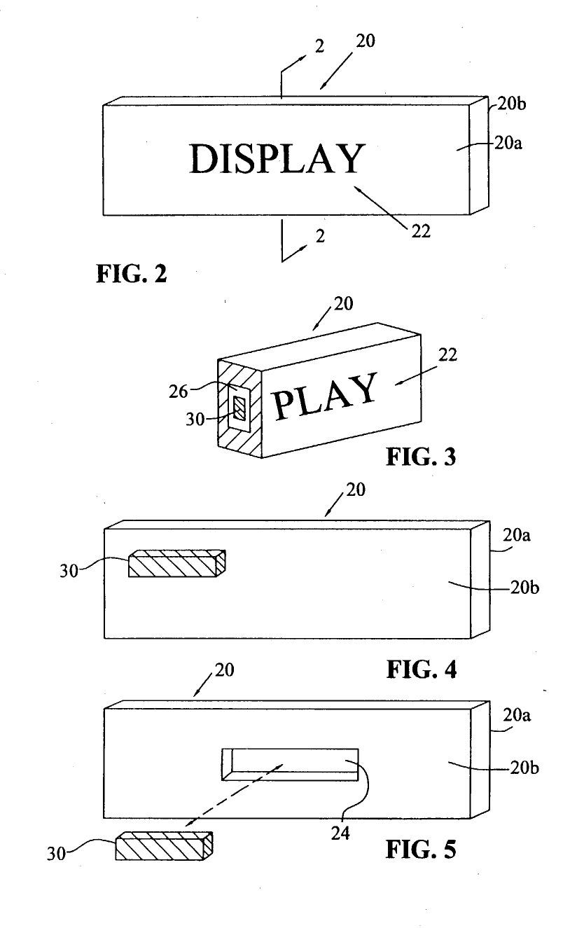

Display 20 is shown in greater detail in FIG. 2. Display 20 may be a VFD, LCD, LED or gas plasma display. More specifically, display 20 may be a CIG VFD, a COG LCD or other suitable display technology device. Display 20 varies in length, width, and height depending on-the apparatus in which it is used. For example, display 20 in radio receiver 12 may have a considerably smaller display 20 than receiver 13. Display 20 has a front side 20a and a back side 20b. Front side 20 includes one or more light-emitting elements 22 that form the characters, text and graphics illuminating display 20. Depending on the display technology used in display 20, light-emitting elements 22 may include a phosphor segment, a pixel, a white-LED or other light-emitting device known in the art and suitable for use in display 20.

In one embodiment of the present invention, display 20 includes integrated antenna 30. Antenna 30 may be integrated with display 20 in multiple ways. In one form of this embodiment shown in FIG. 3, display 20 defines cavity 26 in which antenna 30 is disposed. The exact size and shape of antenna 30 varies depending on the size of display 20, the size and shape of cavity 26, and the requirements of the desired RF band. Antenna 30 may be formed of any type of conductive material, and antenna 30 may also be printed on a transparent conductor or chip. While antenna 30 may be any antenna capable of receiving RF signals, in an exemplary embodiment of the present invention, antenna 30 is Bluetooth® antenna capable of operating in the 2.4 GHz ISM band.

Another form of this embodiment of the present invention is shown in FIG. 4. Antenna 30 is mounted to back side 20b of display 20. In this form of the present invention, antenna 30 may be mounted to display 20 by any conventional method of attachment, including, but not limited to, soldering, and an adhesive such as glue or epoxy. While antenna 30 may also be mounted to front side 22a of display 20, in the exemplary embodiment, antenna 30 is mounted to back side 22b for aesthetic reasons.

In still another form of this embodiment of the present invention shown in FIG. 5, back side 20b of display 20 defines aperture 24 in which antenna 30 is disposed. In this form of the present invention, aperture 24 may be covered to retain antenna 30. If aperture 24 is uncovered, antenna 30 may be secured within aperture 24 by soldering, glue, epoxy, plug, or other conventional attachment method. Aperture 24 may also be sized to the exact specifications of antenna 30 so antenna 30 securely fits within aperture 24. Aperture 24 may also be defined in front side 20a of display 20.

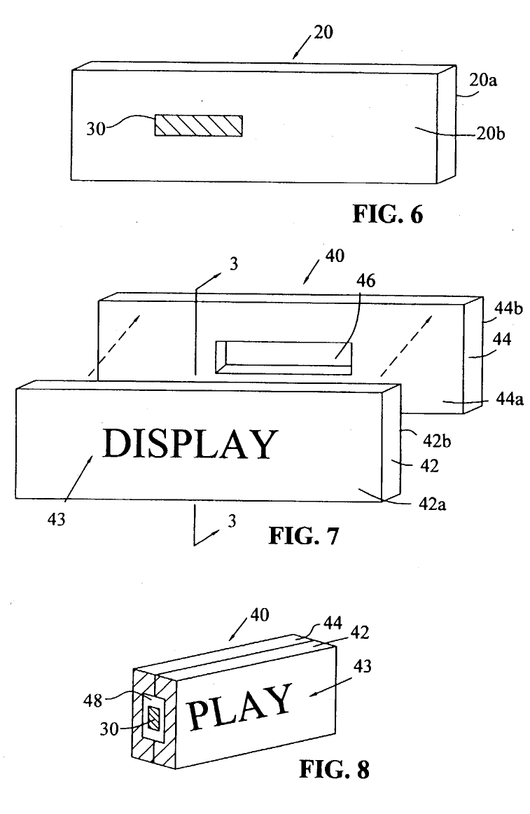

Yet another form of this embodiment of the present invention is illustrated in FIG. 6. Antenna 30 is shown to be formed on the back side 20b of display 20. In this form of the present invention, a conductive antenna pattern is printed directly on back side 20b of display 20 using conventional methods. The conductive pattern forms antenna 30 and is dependent on frequency and design requirements. Antenna 30 may also be formed on display 20 by printing a conductive pattern on a dielectric substrate and then attaching the substrate to display 20. While antenna 30 is shown in FIG. 6 as being printed on back side 20b of display 20, antenna 30 may also be printed on front side 20a.

In another embodiment of the present invention shown in FIGS. 7 and 8, display 40 includes first planar layer 42 and second planar layer 44 adjacent first planar layer 42. First planar layer 42 has front side 42a and back side 42b, and second planar layer 44 has front side 44a and back side 44b. First planar layer 42 includes light-emitting element 43 that form the characters, text and graphics which illuminate display 40. As described above, depending on the display technology used in display 40, light-emitting elements 43 may include a phosphor segment, a pixel, a white-LED or other light-emitting device known in the art and suitable for use in display 40.

Back side 42b and front side 44a define apertures 46, 47 (aperture 47 not shown). Individually, apertures 46, 47 may not be suitably sized to accommodate antenna 30; however, as shown in FIG. 8, when planar layers 42, 44 are positioned adjacent each other to form display 40, apertures 46, 47 together define cavity 48 in which antenna 30 is disposed.

In another form of this embodiment of the present invention (not shown), antenna 30 is printed on back side 42b of first planar layer 42 or on front side 44a of second planar layer 44.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An automobile entertainment apparatus comprising:
a receiver; and
a display associated with said receiver, the display including an antenna integrated with said display

2. The entertainment apparatus of claim 1 wherein the antenna is mounted to the display.

3. The entertainment apparatus of claim 1 wherein the display defines a cavity in which the antenna is disposed.

4. The entertainment apparatus of claim 1 wherein the display defines an aperture in which the antenna is disposed.

5. The entertainment apparatus of claim 1 wherein the antenna is formed on the display.

6. The entertainment apparatus of claim 1 wherein the display is comprised of a first planar layer and a second planar layer adjacent the first layer.

7. The entertainment apparatus of claim 6 wherein the first and second layers together define a cavity in which the antenna is disposed.

8. The entertainment apparatus of claim 1 wherein the entertainment apparatus also includes a circuit board in communication with RF receiving circuitry.

9. The entertainment apparatus of claim 8 wherein the display is adapted to be coupled to said circuit board.

10. The entertainment apparatus of claim 9 wherein said antenna is adapted to receive a signal from a remote control device and communicate the signal to said circuit board.

11. A display for use in an automobile entertainment apparatus, the apparatus including a receiver associated with both the display and a circuit board in communication with RF circuitry, said display comprising:
a planar layer including one or more light-emitting elements; and
an antenna integrated with said planar layer.

12. The display of claim 11 wherein said antenna is mounted to said planar layer.

13. The display of claim 11 wherein said planar layer defines a cavity in which said antenna is disposed.

14. The display of claim 11 wherein said planar layer defines an aperture in which said antenna is disposed.

15. The display of claim 11 wherein said antenna is formed on said planar layer.

16. The display of claim 11 wherein the display is further comprised of a second planar layer adjacent said planar layer, at least one of said layers adapted to be coupled to the circuit board.

17. The display of claim 16 wherein said planar and second planar layers together define a cavity in which said antenna is disposed.

18. The display of claim 11 wherein said antenna is adapted to receive a signal from a remote control device and communicate the signal to the circuit board.

19. A display for use in an automobile entertainment apparatus, the entertainment apparatus including a receiver associated with both the display and a circuit board in communication with RF circuitry, said display comprising:
a first planar layer including one or more light-emitting elements;
a second planar layer adjacent said first planar layer, said first and second layers together defining a cavity; and
an antenna disposed within the cavity.

20. The display of claim 19 wherein said antenna is adapted to communicate with the RF circuitry.
